(19) United States
(12) Patent Application Publication
(10) Pub. No.: US 2025/0269907 A1
(43) Pub. Date: Aug. 28, 2025

(54) Retractable vehicle mud flap arrangement

(71) Applicant: Joey Page, Burleson, TX (US)

(72) Inventor: Joey Page, Burleson, TX (US)

(21) Appl. No.: 18/590,066

(22) Filed: Feb. 28, 2024

(51) Int. Cl. B62D 25/18

(52) U.S. Cl. CPC B62D 25/182

(57) ABSTRACT

A retractable vehicle mud flap arrangement includes a drive unit, an axle, mud flaps, and a control unit. The axle is operatively connected to the drive unit and designed to be rotated by the drive unit. The mud flaps are suspended from opposing ends of the axle. The control unit is operatively connected to the drive unit and designed to control the operation of the drive unit. The drive unit is actuatable to rotate the drive axle and roll up and retract the mud flaps from an extended position to a retracted position to minimize contact with objects on the ground and damage resulting from such contact upon a vehicle is driven in reverse.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vehicle mud flaps and more particularly pertains to a new retractable vehicle mud flap arrangement for preventing damage to the mud flaps. Some vehicles, such as trucks or tractor trailers, require mud flaps approved by the Department of Transportation (DOT) to promote highway safety. When driving, it is not uncommon for mud flaps to be damaged or torn off, resulting in costly and time-consuming repairs or replacement. By making the mud flaps part of a retractable system, the mud flaps could be retracted and thereby protected from damage. To further explain, while mud flaps often experience normal wear and tear from objects during driving, damage can occur when driving the vehicle in reverse. The mud flaps can contact objects on the ground, such as curbs or parking blocks, for example. They can snag and be torn, or possibly become trapped between the vehicle tires and the objects and be damaged or destroyed as the vehicle backs up. If the mud flaps are retractable, especially during driving in reverse, the mud flaps can be raised a distance sufficient to avoid such damaging objects.

### (2) Description of Related Art Including Information Disclosed Under 37 CFR 1.97 and 1.98.

The prior art relates to vehicle mud flaps. The prior art, as best understood, does not disclose a retractable mud flap system for retracting the mud flaps, such as when driving in reverse.

### BRIEF SUMMARY OF THE INVENTION

An embodiment of the disclosure meets the needs presented above in a retractable vehicle mud flap arrangement generally comprising a drive unit, an axle, mud flaps, and a control unit. The drive unit is designed to be mounted adjacent wheels of a vehicle. The axle is operatively connected to the drive unit and designed to be rotated by the drive unit. The mud flaps are suspended from opposing ends of the axle. The control unit is operatively connected to the drive unit and designed to control the operation of the drive unit. The drive unit is actuatable to rotate the drive axle and roll up and retract the mud flaps from an extended position to a retracted position to minimize contact with objects on the ground and damage resulting from such contact upon a vehicle is driven in reverse.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear view of a retractable vehicle mud flap arrangement according to an embodiment of the disclosure.

FIG. 2 is a rear view of an embodiment of the disclosure.

FIG. 3 is a partial schematic view of an embodiment of the disclosure.

FIG. 4 is a side view of a portion of an embodiment of the disclosure.

FIG. 5 is a rear view of a portion of an embodiment of the disclosure.

FIG. 6 is a side view of a portion of an embodiment of the disclosure.

FIG. 7 is an exploded view of a portion of an embodiment of the disclosure.

### DETAILED DESCRIPTION OF THE INVENTION

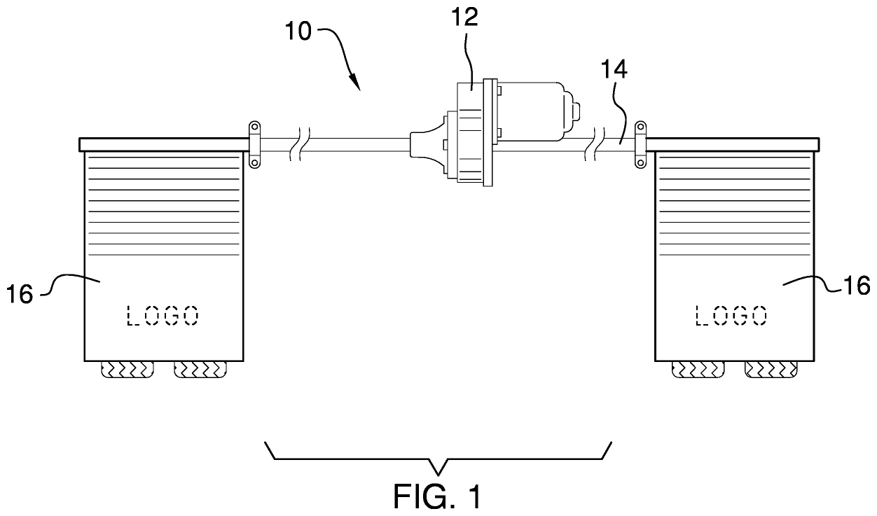

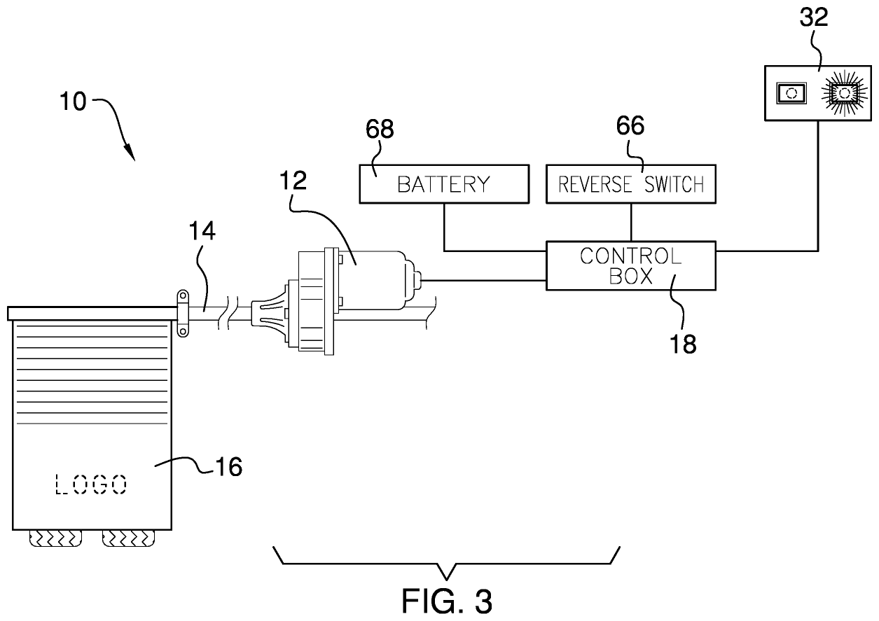

With reference now to the drawings, and in particular to FIGS. 1 through 7 thereof, a new retractable vehicle mud flap arrangement embodying the principles and concepts of an embodiment of the disclosure and generally designated by the reference numeral 10 will be described.

As best illustrated in FIGS. 1 through 7, the retractable vehicle mud flap arrangement 10 generally comprises a drive unit 12, an axle 14, mud flaps 16, and a control unit 18. The drive unit 12 is designed to be mounted adjacent wheels 62 of a vehicle 60. The axle 14 is operatively connected to the drive unit 12 and designed to be rotated by the drive unit 12. The mud flaps 16 are suspended from opposing ends of the axle 14. The control unit 18 is operatively connected to the drive unit 12 and designed to control the operation of the drive unit 12. The drive unit 12 is actuatable to rotate the drive axle 14 and roll up and retract the mud flaps 16 from an extended position to a retracted position to minimize contact with objects 64 on the ground and damage resulting from such contact when a vehicle 60 is driven in reverse.

In accordance with at least one possible embodiment, the control unit 18 is connectable to a reverse indicator or reverse switch 66 of a vehicle 60 to automatically actuate the drive unit 12 to retract the mud flaps 16 when a vehicle 60 is driven in reverse.

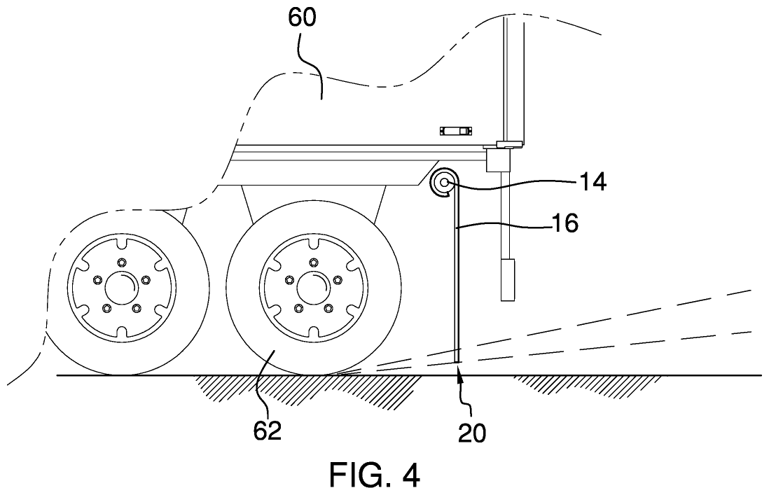

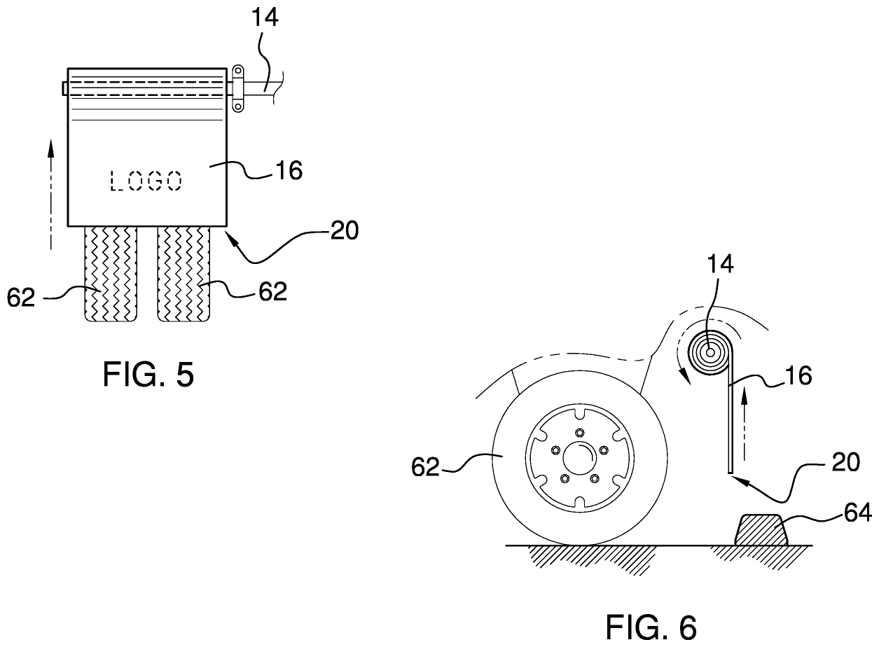

In accordance with at least one possible embodiment, the control unit 18 is designed to actuate the drive unit 12 and rotate the axle 14 in a first direction, such as a clockwise or counterclockwise direction, until the mud flaps 16 are retracted to the retracted position in which the lower edge 20 of each of the mud flaps 16 is positioned about halfway up the height of its adjacent tire 62. The control unit 18 is also designed to actuate the drive unit 12 and rotate the axle 14 in a second direction opposite the first direction until the mud flaps 16 are extended to the extended position in which the lower edge 20 of each of the mud flaps 16 is positioned three to six inches from the ground. FIG. 4 shows an example of the extended position in which the lower edge 20 is three inches from the ground. The dotted lines show the trajectory of objects, such as rocks, that could be propelled by the tires 62, both at a three-inch height and a six-inch height. FIGS. 5 and 6 show an example of the retracted position in which the mud flaps 16 have been retracted such that the lower edge 20 is about at the halfway or midway point of the tire 62. As shown in FIG. 6, this position allows the mud flaps 16 to clear an object 64 on the ground, such as a parking block or curb. It should be understood that the retracted position could be a position in which the lower edge 20 is higher or lower off of the ground.

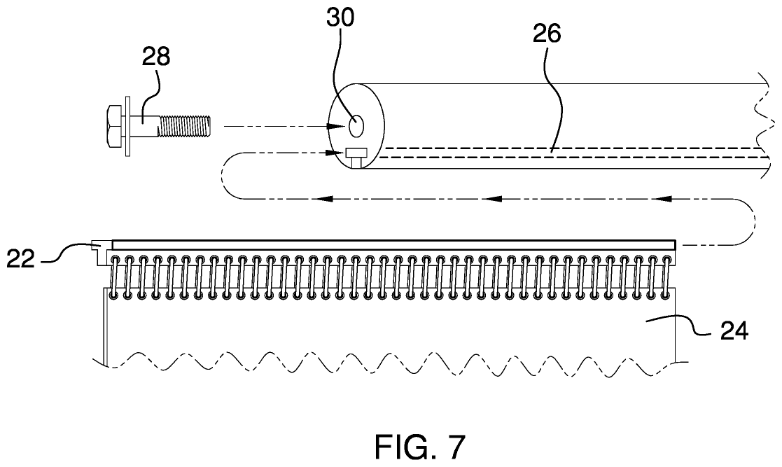

In accordance with at least one possible embodiment as shown in FIG. 7, each of the mud flaps 16 includes an upper mounting bracket 22 and a flap portion 24 suspended in a freely pivotable or freely swinging manner from the upper mounting bracket 22. The axle 14 also includes a mounting arrangement designed to receive and hold the upper mounting bracket 22 of each of the mud flaps 16 such that upon rotation of the axle 14 the flap portion 24 is rolled up around the axle 14.

In accordance with at least one possible embodiment, the mounting arrangement includes an open-ended slot 26 in the drive axle 14 to permit sliding in and out of the upper mounting bracket 22 to permit insertion and removal of the mud flaps 16, as well as a securing bolt 28 designed to be inserted into a receptacle 30 in the axle 14 to cover the open-ended slot 26 to secure the upper mounting bracket 22 in the open-ended slot 26.

In accordance with at least one possible embodiment, the retractable vehicle mud flap arrangement 10 further includes a status indicator 32 operatively connected to the control unit 18 and designed to be mounted on a surface in a cab of a vehicle 60 and to indicate whether the mud flaps 16 are in the extended position or the retracted position.

In accordance with at least one possible embodiment, the retractable vehicle mud flap arrangement 10 further includes a manual control button arrangement, which could be part of the status indicator 32, operatively connected to the control unit 18 to permit manual actuation of the drive unit 12 to permit a user to selectively retract and extend the mud flaps 16.

In accordance with at least one possible embodiment, the control unit 18 is designed to actuate the drive unit 12 to automatically extend the mud flaps 16 upon expiration of a predetermined amount of time. In other words, once the mud flaps 16 are retracted due to reverse driving or similar situation, it is necessary to extend them again when normal forward driving resumes. A timer can be set to a time that is sufficient to allow a driver to complete a reverse driving action with the mud flaps 16 retracted and clear of any danger. Once the timer is up and the reverse driving action has presumably been completed, the mud flaps 16 automatically extend so the vehicle 60 is ready to be driven again safely.

In accordance with at least one possible embodiment, the drive unit 12 includes a battery or is connectable to a battery 68 of a vehicle 60 to supply power to the drive unit 12.

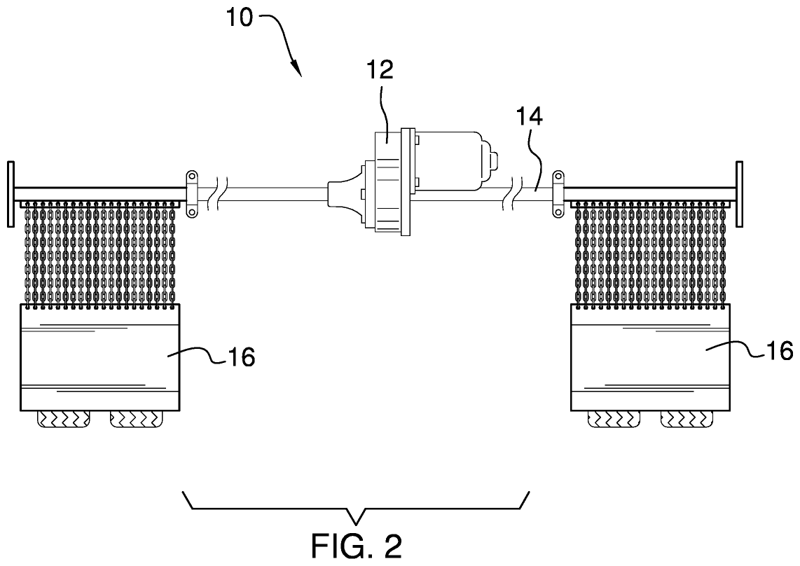

In accordance with at least one possible embodiment, each of the mud flaps is a standard hinged mud flap, as shown in FIG. 1, or a weighted steel plate suspended from chain link material, as shown in FIG. 2.

In order to protect mud flaps 16 using the retractable vehicle mud flap arrangement 10, first the drive unit 12, the axle 14, and the control unit 18 must be mounted on a vehicle 60. The mud flaps 16 are suspended from opposing ends of the axle 14, which can be done before or after mounting the axle 14. A user can then drive his vehicle 60 normally. However, when driving the vehicle 60 in reverse, the drive unit 12 is actuated to rotate the drive axle 14, which in turn rolls up and retracts the mud flaps 16 from the extended position to the retracted position. In this manner the user can minimize contact of the mud flaps 16 with objects 64 on the ground, and thereby minimize or prevent damage resulting from such contact when the vehicle 60 is driven in reverse.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A retractable vehicle mud flap arrangement comprising:
a drive unit being configured to be mounted adjacent wheels of a vehicle;
an axle being operatively connected to said drive unit and configured to be rotated by said drive unit;
mud flaps being suspended from opposing ends of said axle;
a control unit being operatively connected to said drive unit and configured to control the operation of said drive unit; and
said drive unit being actuatable to rotate said drive axle and roll up and retract said mud flaps from an extended position to a retracted position to minimize contact with objects on the ground and damage resulting from such contact upon a vehicle being driven in reverse.

2. The retractable vehicle mud flap arrangement of claim 1, wherein said control unit is connectable to a reverse indicator or reverse switch of a vehicle to automatically actuate said drive unit to retract said mud flaps upon a vehicle being driven in reverse.

3. The retractable vehicle mud flap arrangement of claim 2, wherein:
said control unit is configured to actuate said drive unit and rotate said axle in a first direction until said mud flaps are retracted to said retracted position in which the lower edge of each of said mud flaps is positioned about halfway up the height of its adjacent tire; and
said control unit is configured to actuate said drive unit and rotate said axle in a second direction opposite said first direction until said mud flaps are extended to said extended position in which the lower edge of each of said mud flaps is positioned three to six inches from the ground.

4. The retractable vehicle mud flap arrangement of claim 3, wherein:
each of said mud flaps comprises an upper mounting bracket and a flap portion suspended in a freely pivotable manner from said upper mounting bracket; and
said axle comprises a mounting arrangement configured to receive and hold said upper mounting bracket of each of said mud flaps such that upon rotation of said axle said flap portion is rolled up around said axle.

5. The retractable vehicle mud flap arrangement of claim 4, wherein said mounting arrangement comprises:
an open-ended slot in said drive axle to permit sliding in and out of said upper mounting bracket to permit insertion and removal of said mud flaps; and
a securing bolt configured to be inserted into a receptacle in said axle to cover said open-ended slot to secure said upper mounting bracket in said open-ended lot.

6. The retractable vehicle mud flap arrangement of claim 5, further comprising a status indicator operatively connected to said control unit and configured to be mounted on a surface in a cab of a vehicle and to indicate whether said mud flaps are in said extended position or said retracted position.

7. The retractable vehicle mud flap arrangement of claim 6, further comprising a manual control button arrangement operatively connected to said control unit to permit manual actuation of said drive unit to permit a user to selectively retract and extend said mud flaps.

8. The retractable vehicle mud flap arrangement of claim 7, wherein said control unit is configured to actuate said drive unit to automatically extend said mud flaps upon expiration of a predetermined amount of time.

9. The retractable vehicle mud flap arrangement of claim 8, wherein said drive unit comprises a battery or is connectable to a battery of a vehicle to supply power to said drive unit.

10. The retractable vehicle mud flap arrangement of claim 9, wherein each of said mud flaps comprises a standard hinged mud flap or a weighted steel plate suspended from chain link material.

11. The retractable vehicle mud flap arrangement of claim 1, wherein:
said control unit is configured to actuate said drive unit and rotate said axle in a first direction until said mud flaps are retracted to said retracted position in which the lower edge of each of said mud flaps is positioned about halfway up the height of its adjacent tire; and
said control unit is configured to actuate said drive unit and rotate said axle in a second direction opposite said first direction until said mud flaps are extended to said extended position in which the lower edge of each of said mud flaps is positioned three to six inches from the ground.

12. The retractable vehicle mud flap arrangement of claim 1, wherein:
each of said mud flaps comprises an upper mounting bracket and a flap portion suspended in a freely pivotable manner from said upper mounting bracket; and
said axle comprises a mounting arrangement configured to receive and hold said upper mounting bracket of each of said mud flaps such that upon rotation of said axle said flap portion is rolled up around said axle.

13. The retractable vehicle mud flap arrangement of claim 12, wherein said mounting arrangement comprises:
an open-ended slot in said drive axle to permit sliding in and out of said upper mounting bracket to permit insertion and removal of said mud flaps; and
a securing bolt configured to be inserted into a receptacle in said axle to cover said open-ended slot to secure said upper mounting bracket in said open-ended slot.

14. The retractable vehicle mud flap arrangement of claim 1, further comprising a status indicator operatively connected to said control unit and configured to be mounted on a surface in a cab of a vehicle and to indicate whether said mud flaps are in said extended position or said retracted position.

15. The retractable vehicle mud flap arrangement of claim 1, further comprising a manual control button arrangement operatively connected to said control unit to permit manual actuation of said drive unit to permit a user to selectively retract and extend said mud flaps.

16. The retractable vehicle mud flap arrangement of claim 1, wherein said control unit is configured to actuate said drive unit to automatically extend said mud flaps upon expiration of a predetermined amount of time.

17. The retractable vehicle mud flap arrangement of claim 1, wherein said drive unit comprises a battery or is connectable to a battery of a vehicle to supply power to said drive unit.

18. The retractable vehicle mud flap arrangement of claim 1, wherein each of said mud flaps comprises a standard hinged mud flap or a weighted steel plate suspended from chain link material.

19. A method of protecting mud flaps using the retractable vehicle mud flap arrangement of claim 1 comprising the steps of:
mounting said drive unit, said axle, and said control unit on a vehicle;
suspending said mud flaps from opposing ends of said axle; and
driving said vehicle in reverse and actuating said drive unit and rotating said drive axle and rolling up and retracting said mud flaps from an extended position to a retracted position to minimize contact with objects on the ground and damage resulting from such contact upon said vehicle being driven in reverse.
